(19) United States
(12) Patent Application Publication
(10) Pub. No.: US 2026/0051452 A1
(43) Pub. Date: Feb. 19, 2026

(54) X-RAY TUBES

(71) Applicants: Daniel BENJAMIN, Atlanta, GA (US); Andrew LOFTUS, Atlanta, GA (US); Andrew SICKAFOOSE, Atlanta, GA (US); Matthew VICKERS, Atlanta, GA (US); Evan RUFF, Atlanta, GA (US)

(72) Inventors: Daniel BENJAMIN, Atlanta, GA (US); Andrew LOFTUS, Atlanta, GA (US); Andrew SICKAFOOSE, Atlanta, GA (US); Matthew VICKERS, Atlanta, GA (US); Evan RUFF, Atlanta, GA (US)

(21) Appl. No.: 19/169,796

(22) Filed: Apr. 3, 2025

Related U.S. Application Data
(60) Provisional application No. 63/575,621, filed on Apr. 5, 2024.

(51) Int. Cl. H01J 35/06; H01J 35/12; H01J 35/18; H01J 35/20

(52) U.S. Cl. CPC H01J 35/066; H01J 35/12; H01J 35/18; H01J 35/20; H01J 2235/1204; H01J 2235/1295; H01J 2235/205

(57) ABSTRACT

X-ray tube assemblies having a two-piece anode structure and shaped cathode structures for delivery of X-ray emissions.

### CROSS-REFERENCE TO RELATED APPLICATIONS

This application is a non-provisional of U.S. provisional application 63/575,621 filed Apr. 5, 2024, the entirety of which is incorporated by reference.

### FIELD OF THE INVENTION

Improved X-ray tube assemblies.

### BACKGROUND OF THE INVENTION

The development of small, lightweight X-ray systems and methods allows medical caregivers to obtain radiographic images in a safe and effective manner in a variety of settings. The requirements of these X-ray systems can be different than traditional X-ray equipment. Therefore, there remains a need for an improved X-ray tube that meets the requirements of a portable X-ray system, where such improvements include, but are not limited to, a smaller and higher quality focal spot; additional radiographic shielding to reduce the need for radiographically opaque potting, which reduces the size of the X-ray tube, repeatable and tunable construction to manufacture at large scales, the ability to use various materials as the X-ray target slug to produce more X-ray emission at lower power levels.

For example, in radiography, the X-ray focal spot size can greatly affect the quality of the resulting image. The focal spot measures how tightly the X-ray output is generated on the target. For portable systems in medical applications, the desired focal spot is much less than the focal spot produced by X-ray tubes in existing designs. The ability to achieve a small focal spot can be crucial to obtaining high-resolution radiographic imaging. In conventional designs, electrons within the X-ray tube can impact a target surface at various angles, limiting the minimum size of an effective focal spot. This phenomenon can lead to blurring and reduced image resolution, which might not be suitable for applications that require detailed and high-resolution images.

There remains a need for an improved X-ray tube assembly to address the problems described above, as well as assemblies that can be fabricated from components to refine the X-ray tube during assembly to increase yield.

### SUMMARY OF THE INVENTION

The X-ray tubes described herein are an improvement to conventional X-ray tube designs. For example, a variation of an X-ray tube is a vacuum tube that can include a ceramic structure (such as a tube or other hollow structure), a cathode body sealed to a first end of the ceramic structure; an anode body hermetically sealed to a second end of the ceramic structure; where sealing of the cathode body and anode body to the ceramic structure allows formation of a vacuum tube. The anode body having a borehole extending therethrough intersecting with a conical X-ray window extending radially from the borehole, a target surface located within the borehole and adjacent to the conical X-ray window, the target surface formed to have an angle relative to an axis of the borehole that directs X-ray emission towards the conical X-ray window, where a portion of borehole adjacent to the target surface extends through the anode body to form a tunnel such that the target surface is recessed within the tunnel; wherein an outer surface of the anode body comprises a first portion for coupling to an interior of the ceramic structure and a second portion that is radially offset from the interior of the ceramic structure; and the cathode body having a filament coupled within a central cup portion and configured to emit electrons in an electron beam towards the anode upon the application of a current to the filament.

In one variation of the X-ray tube, the target surface is located at an end of a rod, where the rod is inserted within the borehole opposite to the tunnel. The target surface can comprise a flat surface.

In an additional variation, the X-ray tube can have a cathode body that comprises a recess adjacent to the cup portion and has a stepped surface such that a first portion of the stepped surface is coupled to the interior of the ceramic structure and a second portion of the stepped surface is spaced from the interior of the ceramic structure.

In an additional variation, the X-ray tube can have a filament located adjacent to a filament window within the cup structure and where a surface of the filament window is configured to shape a path of electrons in the electron beam.

Variations of the X-ray tube can include a conducting member located in or adjacent to the conical X-ray window. For example, the conducting member comprises a thin foil material that covers an exterior opening of the conical X-ray window.

Variations of the X-ray tube can include a heat slug affixed to the anode body. Where the anode body can optionally comprise a first material and the heat slug comprises a second material, where a thermal conductivity of the first material is different than a thermal conductivity of the second material. In further variations the heat slug comprises a protrusion that extends partially within the anode body.

In additional variations, the X-ray tube assemblies described herein are incorporated into a monoblock assembly. The monoblock assembly can include an insulating structure housing high voltage components of the monoblock assembly. The monoblock assembly can include the X-ray tube assembly located within a monoblock shell, which can comprise a polymeric material having a conductive coating.

### BRIEF DESCRIPTION OF THE FIGURES

FIG. 1A illustrates an example of components for an X-ray emitter.

FIG. 1B shows the X-ray emitter of FIG. 1A with a portion of the housing removed.

FIG. 1C illustrates another X-ray emitter assembly that has a variation of an X-ray tube assembly.

FIG. 1D shows an example of an insulating structure used in the emitter assembly of FIG. 1C.

FIG. 1E illustrates an external X-ray window 40 separated from a ceramic tube of an X-ray assembly 202.

FIGS. 1F and 1G illustrate various views of the external X-ray window.

FIG. 1H illustrates a variation of a monoblock shell that can replace all or a portion of the housing of FIG. 1A.

FIG. 2 illustrates an example of an improved X-ray tube for use with an X-ray tube assembly.

FIG. 3A shows an exploded view of the X-ray tube of FIG. 2 to illustrate the various components.

FIG. 3B shows a cross-sectional view of an assembled X-ray tube similar to the one shown in FIG. 3A.

FIGS. 4A and 4B show an additional variation of a conducting member for use with the anode body.

FIGS. 4C and 4D illustrate cross-sectional views of variations of anode bodies.

FIG. 4E shows a cross-sectional view variation of an X-ray tube assembly.

FIGS. 5A to 5C illustrate one variation of a cathode housing for use with the X-ray tubes described herein.

FIGS. 6A to 6C illustrate an additional variation of a cathode housing for use with the X-ray tubes described herein.

FIGS. 7A to 7C illustrate a variation of a cathode housing for use with the X-ray tubes described herein with a semi-spherical focusing surface.

FIGS. 8A to 8C illustrate a variation of a cathode housing for use with the X-ray tubes described herein with a spline focusing surface.

FIG. 9A shows a perspective view of rod insert.

FIG. 9B shows a front and side view of a rod insert to illustrate a focal point and effective focal spot of a target surface of a rod insert.

FIGS. 9C to 9E each illustrates perspective views and side cross-sectional views of different variations of target inserts coupled to a high Z material.

FIG. 10 illustrates another example of an improved X-ray tube for use with an X-ray emitter assembly, as shown in FIG. 1C.

FIG. 11A shows an exploded view of the X-ray tube of FIG. 10 illustrating various components of the tube.

FIG. 11B shows a cross-sectional view of an assembled X-ray tube similar to the one shown in FIG. 11A.

FIG. 12 shows a partial cross-sectional view of an improved cathode construction.

FIG. 13A shows a partial cross-section of a heat slug that joins to a rear wall in a monoblock assembly.

FIGS. 13B to 13D show features added between the wall and heat slug to reduce electrical fields at the junction therebetween.

### DETAILED DESCRIPTION

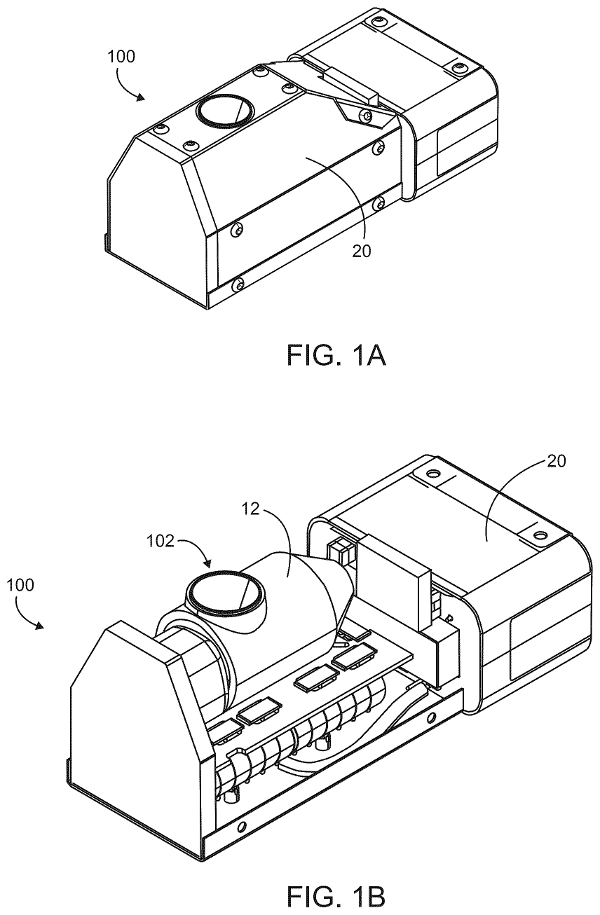

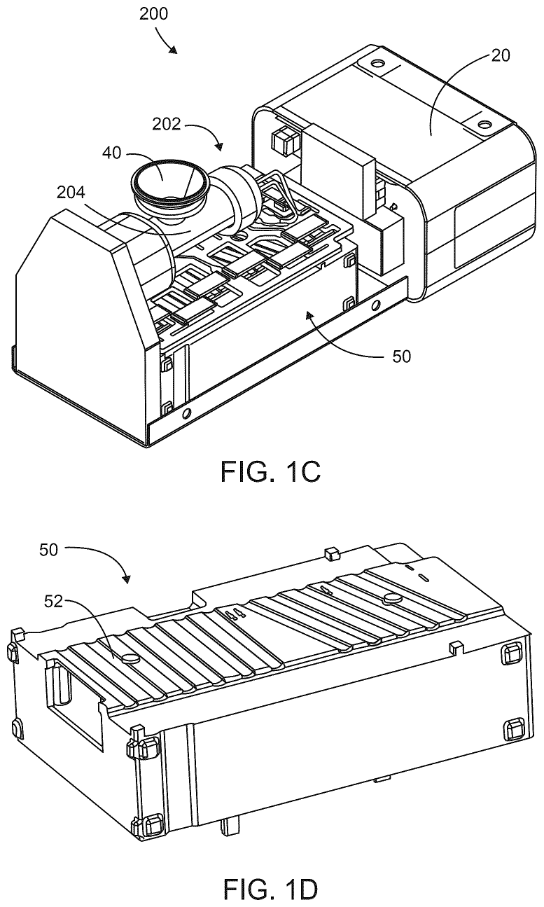

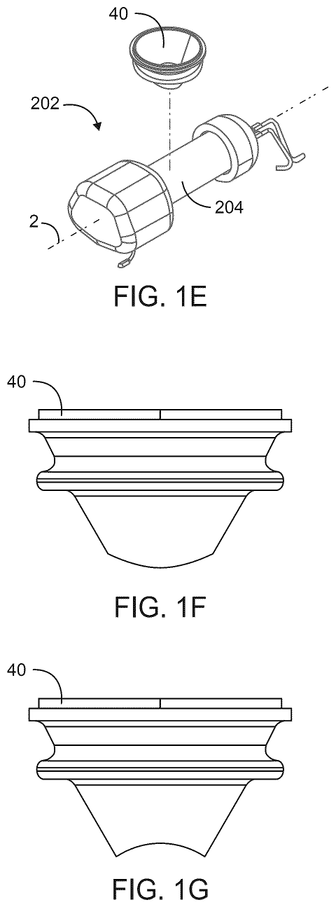

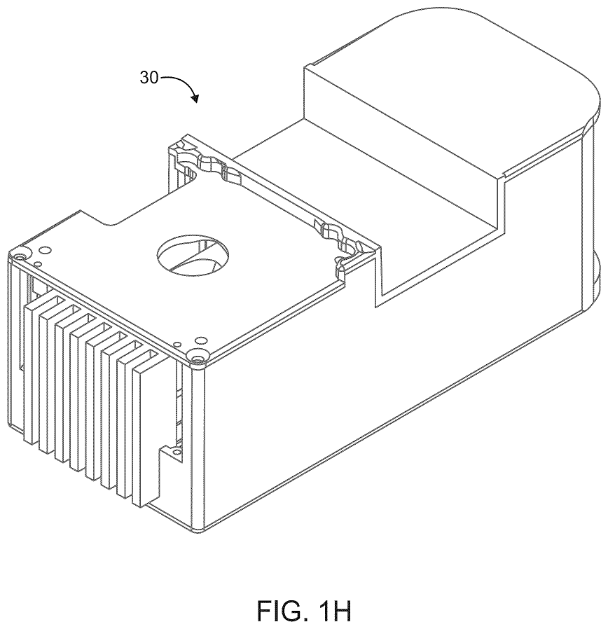

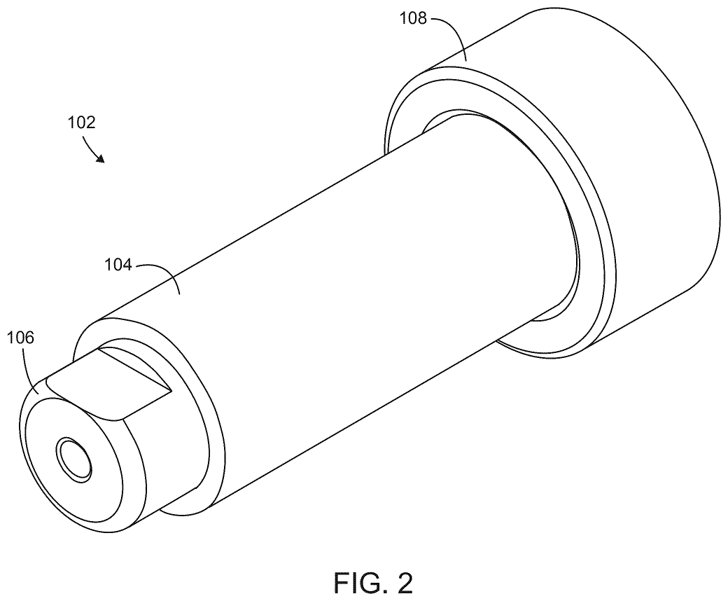

FIGS. 1A and 1B illustrate a variation of an integrated X-ray emitter assembly 100 configured for eventual assembly into a block structure where portions of the housing 20 are removed in FIG. 1B to better illustrate an X-ray tube assembly 102 covered in a potting material 12 and coupled to various components within the emitter assembly 100. It is noted that the figures omit components such as epoxy, radiographic potting, and silicone potting for purposes of showing the X-ray emitter assembly 100.

FIG. 1C illustrates another X-ray emitter assembly 200 having another variation of an X-ray tube assembly 202 as discussed in further detail below. In this variation, the X-ray emitter assembly 100 includes an insulating structure 50 to fixture high voltage components of the assembly 202 in place. For purposes of illustration, the potting material (e.g., 12 in FIG. 1B is omitted in FIG. 1C). In one variation, the insulating structure 50 provides a protective barrier around the high voltage components and provides extra protection against undesired arcing and tracking of currents to various components of the assembly. FIG. 1D shows an example of an insulating structure 50 with various features to reduce the effects of arcing and tracking of currents, for example, the example of FIG. 1D shows the insulating structure 50, which includes undulating features 52. However, additional structures can be incorporated with the structure 50.

FIG. 1C also shows an external X-ray window 40 coupled to a ceramic tube 204 of the X-ray tube 202. FIG. 1E illustrates the external X-ray window 40 separated from the ceramic tube 202 of the X-ray assembly 202. FIG. 1F shows a side view of the external X-ray window (transverse to an axis 2 of the X-ray assembly 202 and FIG. 1G shows a view of the external X-ray window 40 taken along the axis 2. In one variation, the external X-ray window 40 is adhered to the ceramic X-ray tube 204 with an adhesive. The use of the external X-ray window 40 allows X-rays generated in the tube to reach the target exposure area. In one variation, the external X-ray window 40 is fabricated from a polymer, including but not limited to polyetherimide (e.g., ULTEM® supplied by SHPP Global Technologies B.V.) The window can also be coated with various materials to improve the performance of the X-ray tube emitter. For example, the external X-ray window 40 can be coated with a conductive material (graphite, or other low-Z metal, or other various metals) to allow a continuous conductor on the outside of the monoblock assembly. The thickness of the coating can be thin relative to the thickness of the polymer of the external X-ray window 40 (e.g., 100 um or less coating thickness and 1 mm or greater polymer thickness).

FIG. 1H illustrates a variation of a monoblock shell 30 that can replace all or a portion of the housing (see housing 20 in FIG. 1B). The monoblock shell 30 can encase the x-ray tube (not shown) and other high-voltage components. In some variations, the shell is fabricated from aluminum sheet metal. Alternatively, or in combination, the shell 30 can comprise a polymeric material (e.g., ULTEM) coated with a conductive material using plating, deposition, or alternate coating means. The polymer material of the shell 40 serves as a protective barrier against arcing or tracking from the high voltage around the assembly to the grounding electrode of the shell. In additional variations, some areas of a monoblock shell 40 could be fabricated from metal and lined inside with ULTEM. In additional variations, the shell 40 can include combinations of the constructions discussed herein (e.g., partial metal sheeting, partial ULTEM, plated ULTEM, etc.)

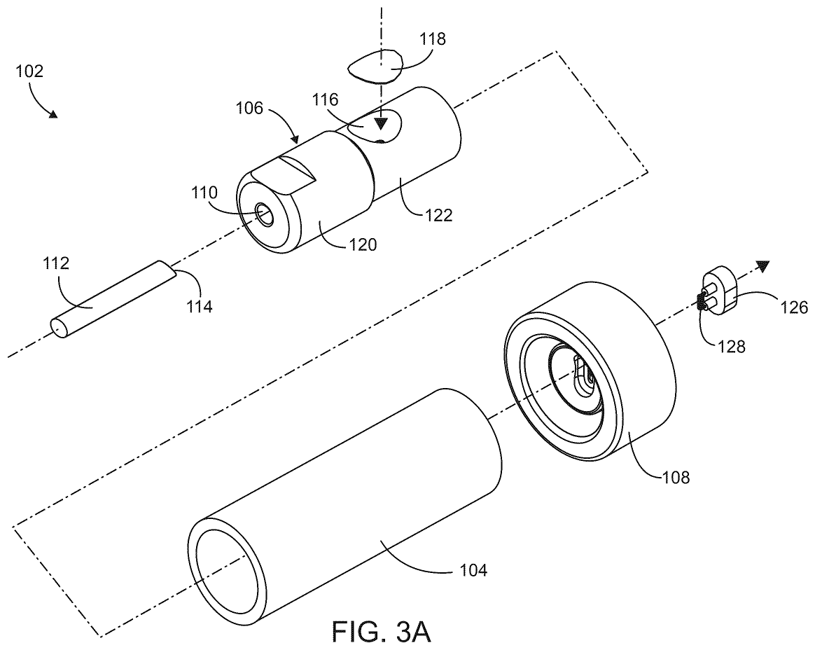

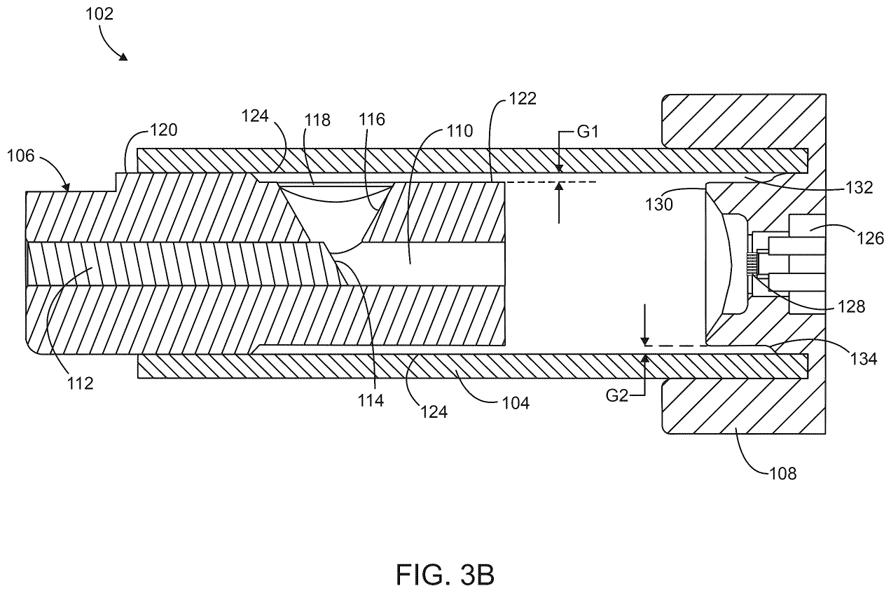

FIG. 2 illustrates an example of an improved X-ray tube 102 for use with an X-ray emitter assembly 100, as shown in FIG. 1A. In this illustration, the X-ray tube is shown without surrounding potting to show various components of the X-ray tube 102, including a ceramic tube 104 having an anode body 106 and a cathode body 108 coupled to opposite ends of the ceramic tube 104. FIG. 3A shows an exploded view of the X-ray tube 102 of FIG. 2 to illustrate the various components. As shown, the body 106 comprises a bore 110 that extends through the body 106. The bore 110 allows for the use of a rod insert 112 with an angled target surface or target 114. As described below, the use of a rod insert 112 allows for the target 114 to be a flat surface, where the surface is angled as discussed below, which further directs incident X-rays in a more predictable and homogenous manner than other anode constructions where a curved target surface is formed from a borehole that is machined into an anode.

In one variation of the X-ray tube assembly, the rod insert 110 and anode body 106 are fabricated from a similar material (e.g., tungsten). However, additional variations of the X-ray tube 102 can comprise rod inserts 112 made from a different metal to provide a target 114 that is different than the material forming the anode body 106. In additional variations, the target 114 can comprise a material that is different from the rod insert 112. In any case, the rod insert 112 can be secured within the anode body 106 through brazing or any conventional metal joining process.

FIG. 3A also shows the anode body as having first region 120 and a second region 122, where the first region 120 is sized closely to an interior diameter of the ceramic tube 104 to allow for hermetically sealing of the anode body 106 within the tube 104. In the variation shown in FIG. 3A, the second region 122 of the anode body 106, which includes a conical X-ray window 116, also has a reduced diameter to offset or space the anode body 106 away from a surface of the ceramic tube 104. This spacing increases a creepage distance between the interior of the ceramic tube 104 and the second region 122 of the anode body 106, which was found to reduce electrical tracking within the X-ray tube 102, which is the establishment of one or more conducting paths on the insulated material of the anode body 106. In conventional X-ray tube designs, such tracking results in electrical current spikes or current surges that can damage the components within the X-ray tube and emitter.

FIG. 3A also shows a conductor body 118 that is positioned over the conical X-ray window bore 116. In one variation, the conductor body 118 is a thin foil conductor 118 that minimizes interference with X-rays passing through the X-ray bore 116 but functions to prevent the accumulation of electrons at the insulating surface of the ceramic tube 104 adjacent to the X-ray window 116. In conventional designs, it was found that the accumulation of electrons produces an electrical charge that interferes with the operation of the X-ray tube 102 by deflecting the electron beam (or potentially damaging the ceramic via breakdown), as discussed below.

A cathode body 108 is located on the side of the ceramic tube 104 opposite the anode body 106, where the cathode body 108 houses a filament body 126 having a filament 128 for producing electrons.

FIG. 3B shows a cross-sectional view of an assembled X-ray tube 102 similar to the one shown in FIG. 3A. This cross-sectional view shows the anode body 106 having a first region 120 that is secured to an interior surface 124 of the ceramic tube 104. As discussed above, the portion 122 of the anode body 106 containing the conical X-ray window 116 is stepped down to create a space G1, which reduces the incidence of electrical tracking within the interior of the ceramic tube 104. This also reduces the chance that any tracking will produce a power surge that could damage the electronics of the emitter housing the X-ray tube. The target surface 114 of a rod insert 112 is positioned adjacent to the conical X-ray window 116 within the central bore 110 of the anode body 106. Since X-rays can be emitted in all directions, the portion of the anode body 106 that surrounds the bore tunnel 110 absorbs X-rays that are emitted in undesired directions. The flat target surface 114 also assists in directing the X-rays in a desired direction. As noted above, this increases the predictability and homogeneity of the X-rays generated in the X-ray tube 102 and significantly reduces off-angle emissions and leakage radiation that could otherwise harm the operator of the device.

The X-ray window 116 can also include a conductor body or material 118. As noted above, one variation of this conductor body 118 is a thin foil conductor that covers the opening of the X-ray window 116. As electrons leave the cathode and enter the bore tunnel 110, they collide with the target surface 114 to emit X-rays via the bremsstrahlung effect (and via fluorescence). However, in some conventional designs, it has been found that some electrons simply scatter off of the target surface 114 and collect onto the ceramic face adjacent to an X-ray window. The accumulation of electrons in this region can create a negative charge, which creates a large electric field affecting the trajectory of the electron beam provided by the cathode body 108 or can cause breakdown of the ceramic anode material. This can be observed when an X-ray emitter initially produces acceptable X-ray beam emission, but use over time can result in inconsistent focusing of the X-ray beam as the charge builds from the accumulation of electrons. The presence of the conductor body 118 creates a homogeneous charged surface that distributes any electrical charge to prevent charge build-up. The conductor body 118 is also designed to minimize blockage of X-rays that pass through the X-ray window 116.

The conductor body 118 can also serve a secondary purpose of beam hardening the X-ray beam emitted from the X-ray tube 102. Beam hardening occurs when an X-ray beam travels through an object, causing low-energy photons to be absorbed more than high-energy photons. Otherwise, low-energy photons would be absorbed by the body but would not be diagnostically valuable to producing the radiologic image. Most medical X-ray applications require beam hardening to reduce the likelihood that a patient absorbs a harmful X-ray dose, but conventional devices provide a metallic material outside of the X-ray tube. The presence of the conductor body 118 over the X-ray window 116 of X-ray tube 102 provides inherent filtration of the X-ray beam to pre-harden the X-ray beam.

FIG. 3B also shows a cathode body 108 affixed to the ceramic tube 104 opposite to the anode body 106. The cathode body 108 includes an interior recess 132 that surrounds a center portion 130 of the cathode body 108. The structure of the center portion 130 forms a focusing cup that assists in directing a flow of electrons from the filament 128. In addition, a surface 134 of the recess 132 is stepped to permit spacing of the shaping cup 130 away from the surface 124 of the ceramic tube 104 by a distance G2 to prevent electrical tracking, as discussed above.

The X-ray tube 102 discussed above is intended as one variation of improved X-ray tubes under this disclosure. The following figures illustrate additional variations of alternative features for the anode body, cathode body, rod insert, conducting member, or any other component of the X-ray tube assemblies disclosed herein. It is also contemplated that the alternative features and designs shown herein can be combined with any other feature or design.

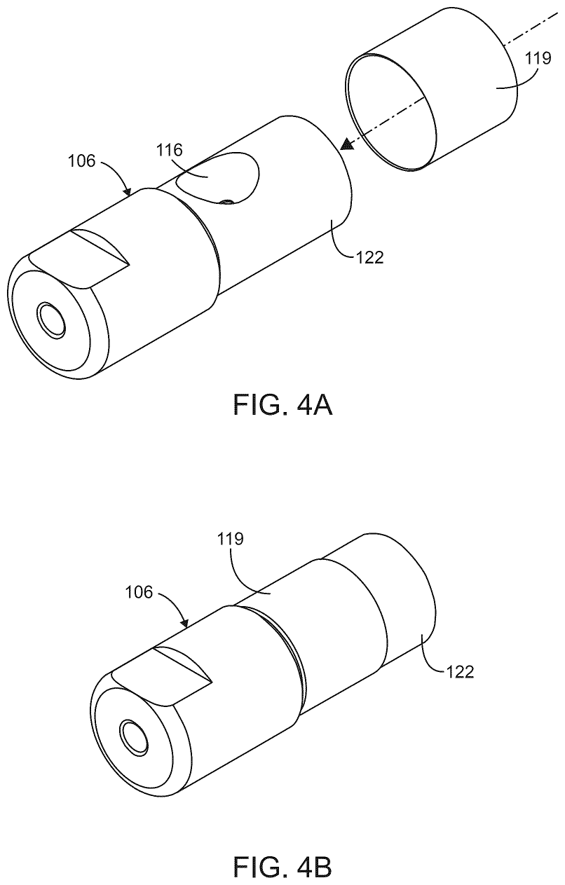

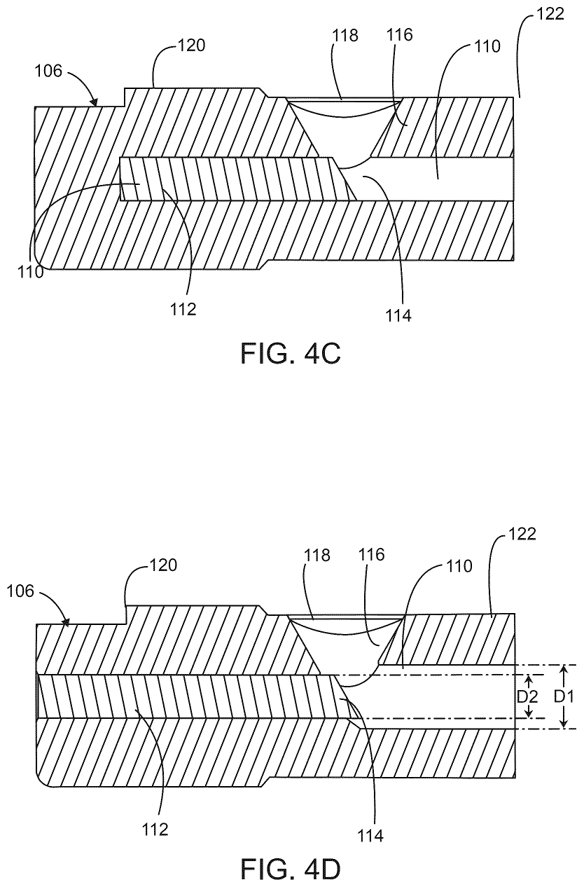

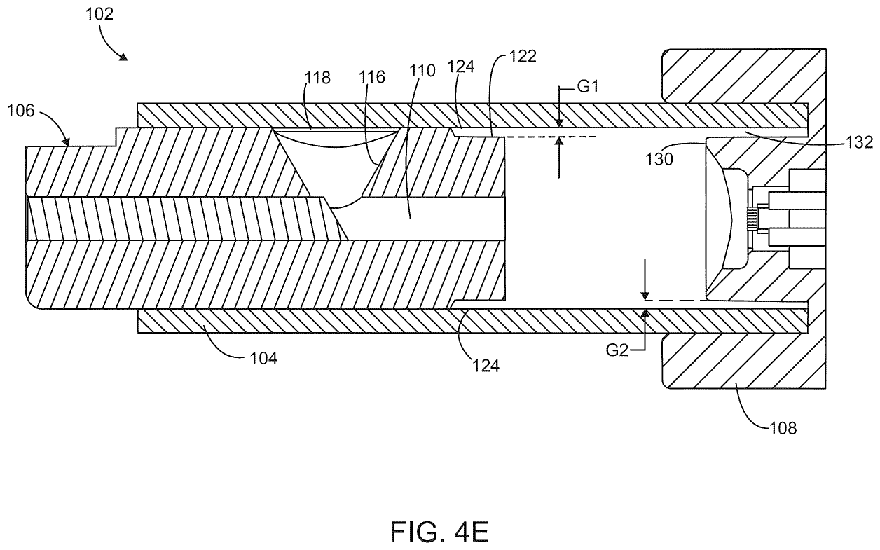

FIG. 4A illustrates an exploded view of an anode body 106 and a conductive member 119. As shown in FIG. 4B, this conductive member 119 is wrapped either partially or totally about a portion 122 of the anode body 106 to cover the X-ray window to prevent a charge building in the X-ray window, as discussed above.

FIG. 4C illustrates a variation of the anode body 106 where the bore 110 does not extend through the anode body 106. As shown, the bore 110 can extend partially within the anode body 106 such that the rod insert 112 is positioned to place the target surface 114 adjacent to the X-ray window 116. FIG. 4D shows a variation where the bore 110 diameter increases adjacent to the target surface 114 such that the portion of the bore that receives the electron beam comprises a larger diameter D1 than a remainder of the bore 110 that houses the insert 112 with a smaller diameter D2.

FIG. 4E shows another variation of an X-ray tube assembly 102 where the X-ray window 116 and conducting member 118 are positioned closer or in contact with an inner surface 122 of the X-ray tube 104. As shown, the end portion of the anode body 120 steps down in region 122 to create a gap G1, as discussed above. The illustrated variation also shows the ceramic tube 104 engaging a recess 132 within the cathode body 108 where the recess is not stepped to create a gap G2 between the interior surface 124 of the ceramic tube 104 and the shaping cup 130.

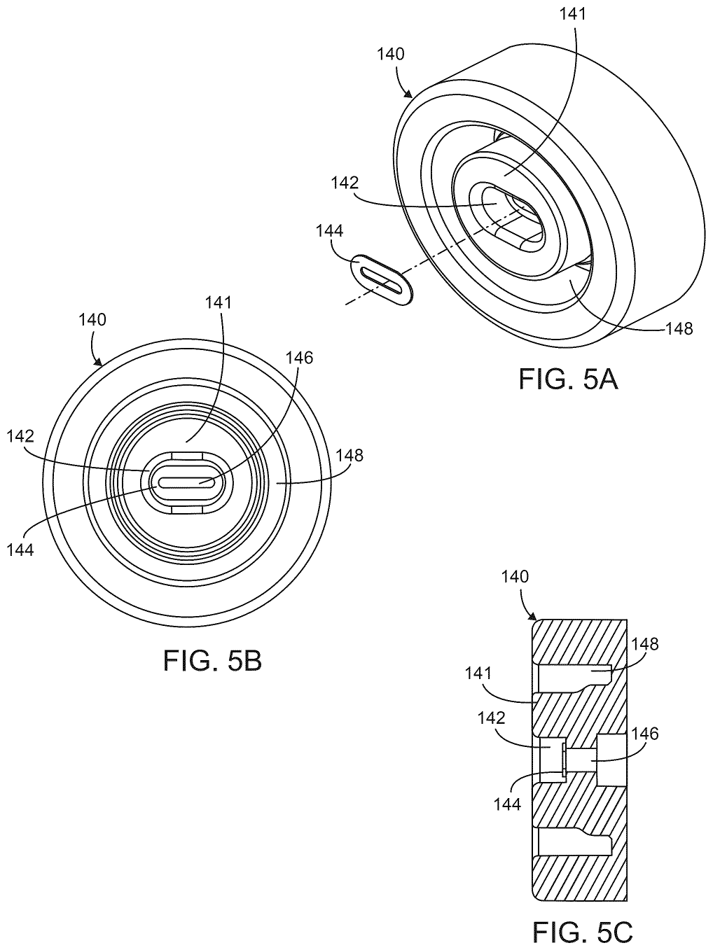

FIGS. 5A to 5C show perspective, front, and cross-sectional views, respectively, of one variation of a cathode housing 140 for use with the X-ray tubes described herein. In these figures, the filament is removed to illustrate the features of the cathode body 140 since the design of the cathode housing 140 shapes the electron beam emitted by the filament when a current is applied to the filament. The cathode housing 140 comprises a metal that, during use, can be negatively charged, using a bipolar configuration, to help direct the flow of electrons toward the anode. Alternatively, a unipolar configuration can be used where either the cathode is grounded, and the anode is held at a positive potential, or the anode is grounded, and the cathode is held at a negative potential. Since the X-ray tube requires a vacuum, the cathode housing 140 further includes an annular groove 148 that receives the ceramic tube (not shown) and allows for the formation of a hermetic seal between the tube and cathode housing 140 while providing a setoff distance as noted above. The center portion 141 of the cathode body 140 functions as a focusing cup to direct the flow of electrons in a desired path.

FIGS. 5A to 5C also illustrate a mask 144 that sits within a filament window 142. The mask 144 can be used to further shape the electron beam emitted from the filament that is located within a filament cavity 146. The mask chokes or virtually shrinks the filament size.

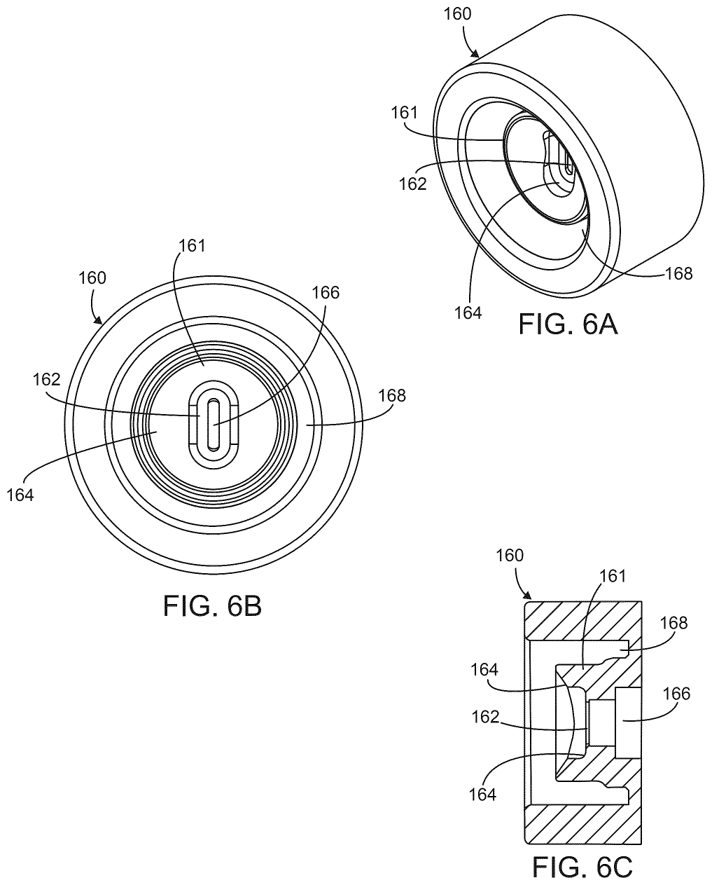

FIGS. 6A to 6C show perspective, front, and cross-sectional views, respectively, of another variation of a cathode housing 160 that uses the geometry of a shaping cup 161 to replace the mask shown in FIGS. 5A to 5C. In this variation, the cathode body 160 also includes a recess 168 that surrounds the shaping cup 161 and allows the cathode body 160 to be joined to a ceramic tube. The filament (not shown) is positioned within a filament recess 166 that is adjacent to a filament window 162. The shaping cup 161 can have one or more curved surfaces 164 (e.g., parabolic, hyperbolic, partially spherical, etc.) that direct the shape of the electron beam. Such a configuration replaces the mask shown in FIGS. 5A to 5C. In additional variations, a cathode can be constructed with a parabolic surface with a mask as described above.

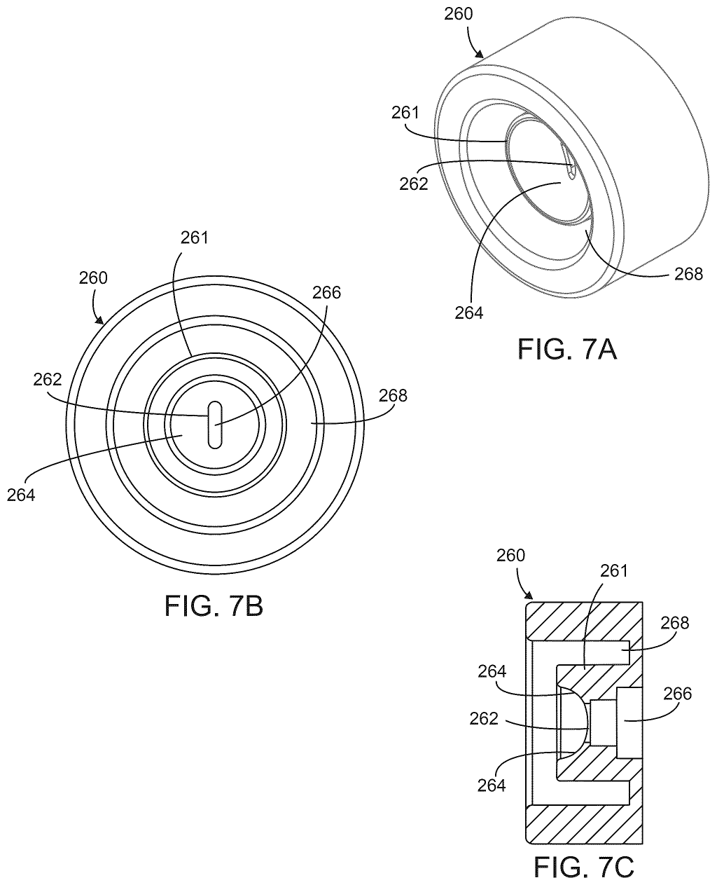

FIGS. 7A to 7C illustrate perspective, front, and cross-sectional views, respectively, of another variation of a cathode housing 260 where an interior of the focusing cup 261 comprises a geometry of a semi-spherical surface 264 to preferentially direct the electron beam. As with previous variations, the cathode body 260 also includes a recess 268 that surrounds the shaping cup 261, which allows the cathode body 260 to be joined to a ceramic tube. The filament (not shown) is positioned within a filament recess 266 that is adjacent to a filament window 262.

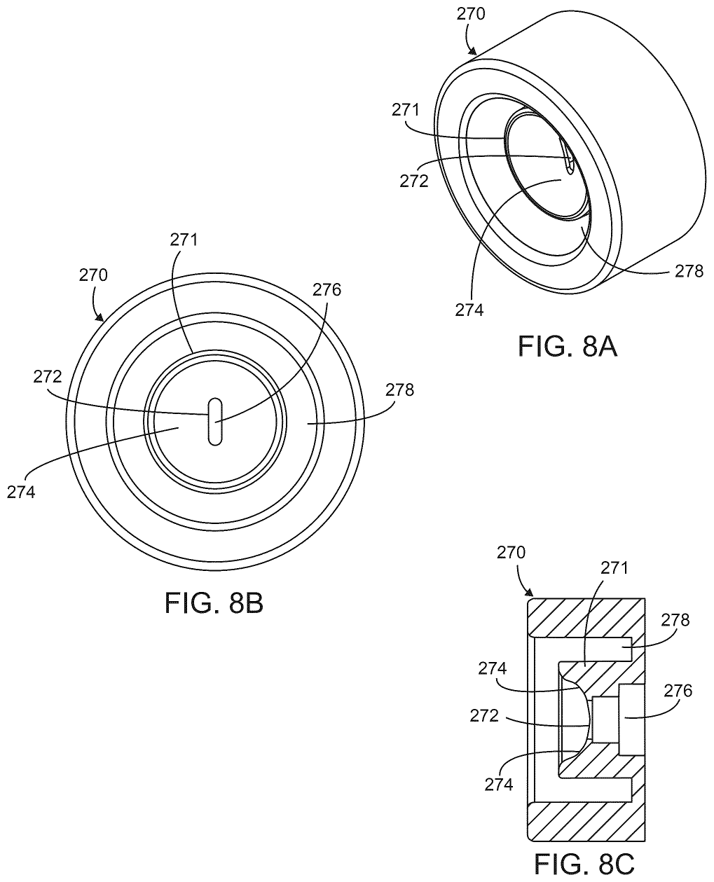

FIGS. 8A to 8C illustrate perspective, front, and cross-sectional views, respectively, of another variation of a cathode housing 270 where an interior of the focusing cup 271 comprises a geometry of several splined surfaces 274 to preferentially direct the electron beam. As with previous variations, the cathode body 270 also includes a recess 278 that surrounds the shaping cup 21, which allows the cathode body 270 to be joined to a ceramic tube. The filament (not shown) is positioned within a filament recess 276 that is adjacent to a filament window 272.

In each of the variations of the cathode, a mask can be used in addition to the shaped surfaces discussed above.

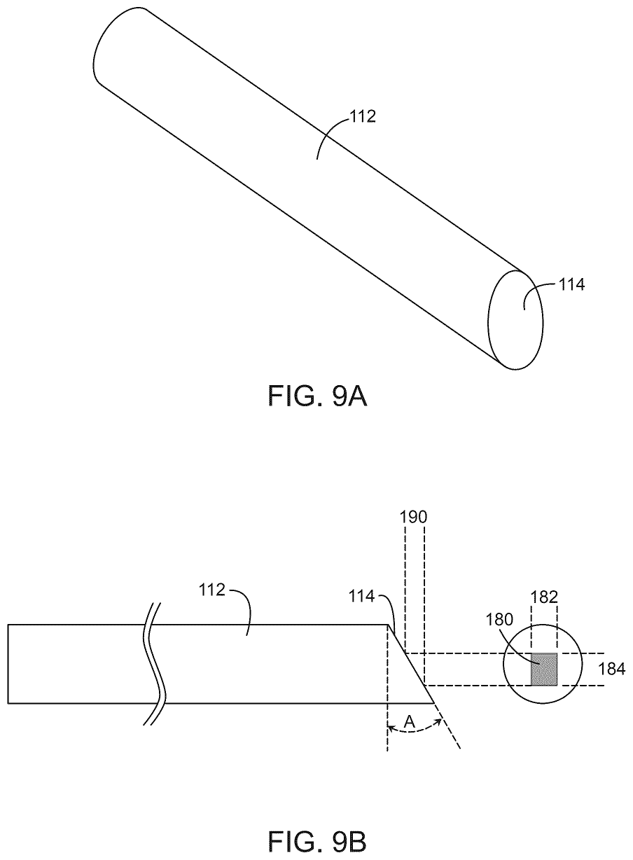

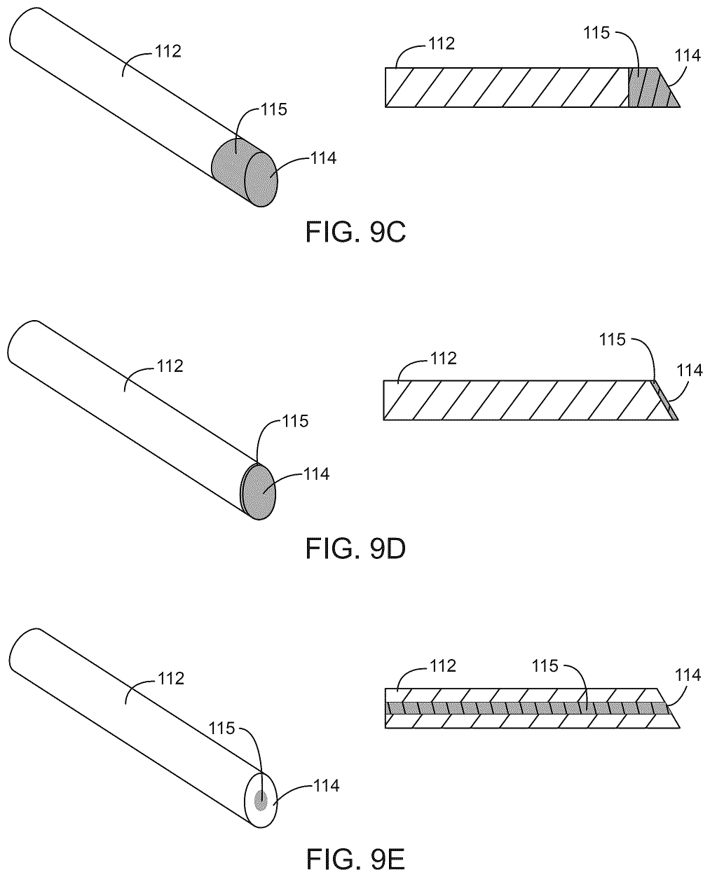

FIG. 9A shows a variation of a rod insert 112 having a target surface 114 that emits X-rays when the beam of electrons from the cathode body collides with the target surface 114. As shown, the target surface 114 is angled to emit X-rays towards the X-ray window bore in the anode body. FIG. 9B shows an example of a rod insert 112 having a target surface 114 with angle A. In addition, FIG. 9B illustrates a focal point 180 of the target surface 114, having a width 182 and height 184 along the inclined flat surface 114. This geometry results in an effective focal spot, as shown by 190. Changing the nominal angle A, has an impact on the emission of X-rays from the X-ray assembly. Typically, a larger angle produces a larger spread of X-rays. The target surfaces 114 of the X-ray tube assemblies described herein can include any range of angles depending on the application. However, some examples include an angle between 15-35 degrees. FIGS. 9A and 9B also show variations of a rod insert 112 comprised of a single material, e.g., tungsten, such that the target surface 114 is the same material. However, in some variations, the X-ray assembly will benefit from the use of higher Z materials as the target surface 114. In some variations, the entire rod insert 112 can comprise a higher Z material. Alternatively, FIGS. 9C to 9E each illustrate perspective views and cross-sectional side views of different variations of target inserts 112 coupled to a high Z material 114 such that the target surface 114 comprises the higher Z or a second material 115. FIG. 9C illustrates a second material 115 coupled to a rod insert 112 such that the target surface 114 comprises the second material 115. FIG. 9D shows the target insert 112 having a coating or plating 114 comprising the second material 115. Alternatively, FIG. 9E shows a second material 115 forming a core within the target insert 112 such that the focal point of the surface 114, discussed above, comprises a material 115 different from the rod insert 112 material. Examples of such high Z materials include but are not limited to, gold, platinum, bismuth, or uranium.

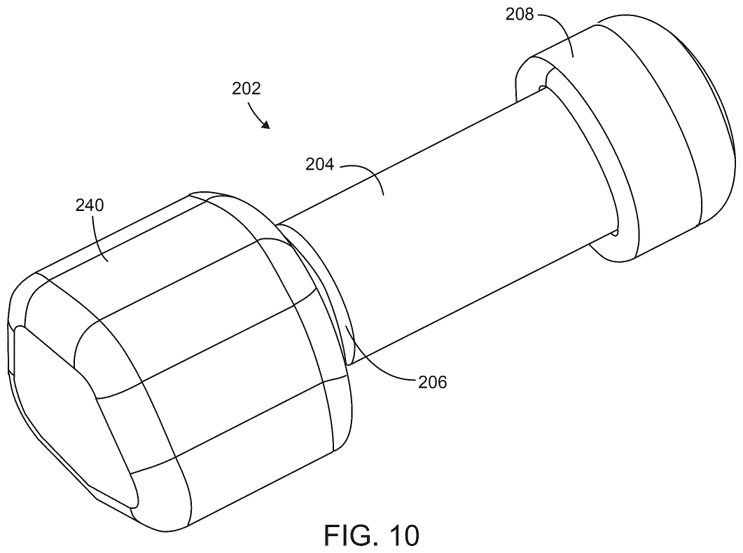

FIG. 10 illustrates another example of an improved X-ray tube 202 for use with an X-ray emitter assembly 200, as shown in FIG. 1C. Again, the X-ray tube 202 is shown without surrounding potting to show various components of the X-ray tube 202, including a ceramic tube 204 having an anode body 206 and a cathode body 208 coupled to opposite ends of the ceramic tube 204. In this variation, the X-ray tube 202 includes a heat slug 240 coupled to the anode body 206. The variation of FIG. 10 increases heat transfer away from the target rod (not shown), as discussed below.

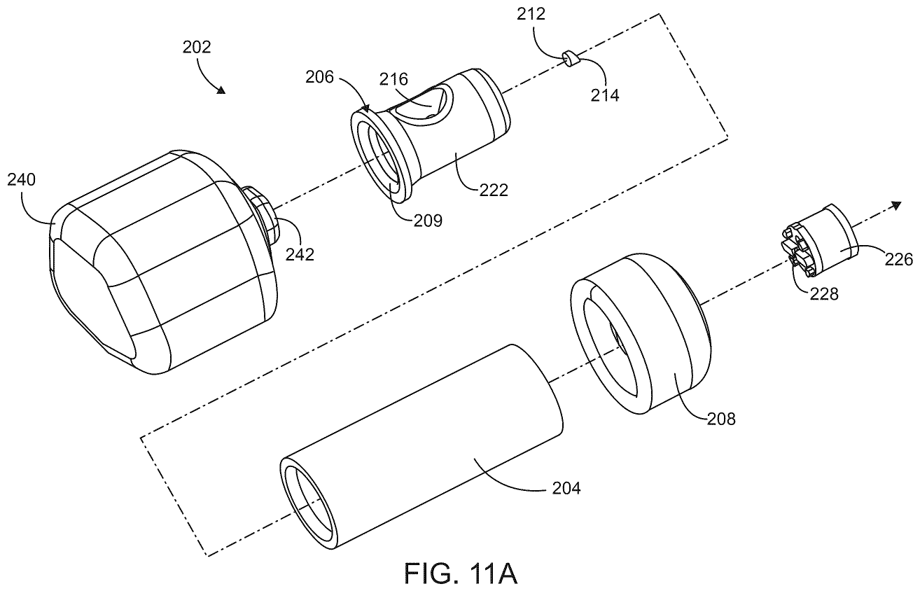

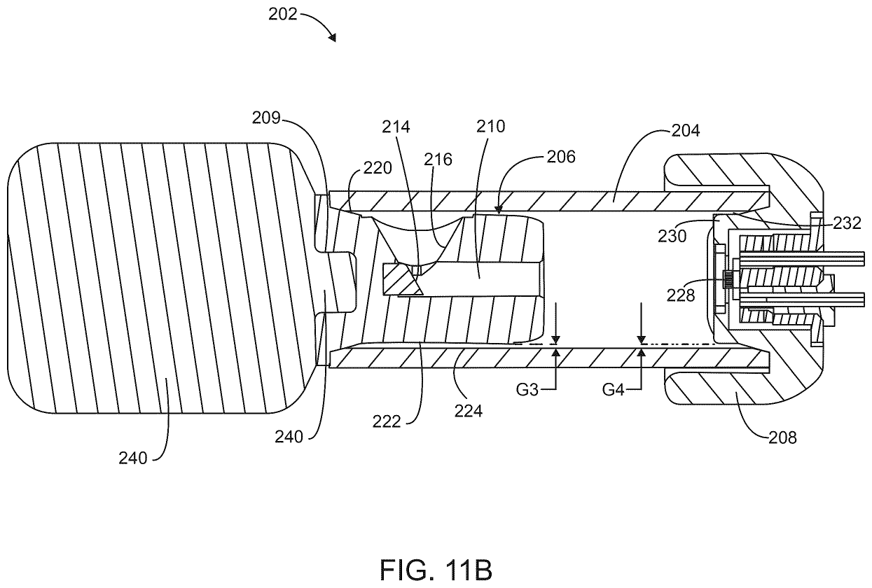

FIG. 11A shows an exploded view of the X-ray tube 202 of FIG. 10 illustrating various components of the tube 202. As shown, the anode body 206 comprises a bore 210 that extends within the body 206. As discussed herein, the bore can extend through the entire anode body 206 or partially through the anode body 206. A rod insert 212 with an angled target surface or target 214 is positioned within the bore in the anode body 206. As described above, the use of a rod insert 212 allows for the target 214 to be a flat surface and angled to direct incident X-rays in a more predictable and homogenous manner than other anode constructions. While FIG. 11A does not show the conductor body shown in FIG. 3A, it is noted that any of the features of any X-ray tube or other components described herein can be combined with the alternate variations discussed herein. FIG. 11A also shows a heat slug 240 comprising a protrusion 242 that is positioned within a cavity 209 of the anode body 206. In previous variations, a heat sink (not shown) was joined to an anode body using a fastening means (e.g., a screw and thermal paste). In the illustrated variation, the protrusion 242 of the heat slug 240 is inserted into the anode cavity 209, and the parts 240, 206 are brazed together to become a singular piece. FIG. 11A also shows a cathode body 208 located on the side of the ceramic tube 204 that is opposite to the anode body 206, where the cathode body 208 houses a filament body 226 having a filament 228 for producing electrons.

FIG. 11B shows a cross-sectional view of an assembled X-ray tube 202 similar to the one shown in FIG. 11A. This cross-sectional view shows the anode body 206 having a first region 220 that is secured to an interior surface 224 of the ceramic tube 204. As discussed above, the portion 222 of the anode body 206 containing the conical X-ray window 216 is stepped down to create a space G3, which reduces the incidence of electrical tracking within the interior of the ceramic tube 204. This also reduces the chance that any tracking will produce a power surge that could damage the electronics of the emitter housing the X-ray tube. The target surface 214 of a rod insert 212 is positioned adjacent to the conical X-ray window 216 within the central bore 210 of the anode body 206. Since X-rays can be emitted in all directions, the bore tunnel 210 absorbs X-rays that are emitted in undesired directions. The flat target surface 214 also assists in directing the X-rays in a desired direction. As noted above, this increases the predictability and homogeneity of the X-rays generated in the X-ray tube 202 and significantly reduces off-angle emissions and leakage radiation that could otherwise harm the operator of the device. The X-ray window 216 can also include a conductor body or material (not shown in FIG. 11B but as discussed above).

FIG. 11B also shows a cathode body 208 affixed to the ceramic tube 204 opposite to the anode body 206. The cathode body 208 includes an interior recess 232 that surrounds a center portion 230 of the cathode body 208. The structure of the center portion 230 forms a focusing cup that assists in directing a flow of electrons from the filament 228. In addition, a surface of the recess 232 is stepped to permit spacing of the shaping cup 230 away from the surface 224 of the ceramic tube 204 by a distance G4 to prevent electrical tracking, as discussed herein.

FIG. 11B also shows a heat slug 240 with a protrusion 240 inserted into a cavity 209 of the anode 206. As noted above, the heat slug 240 is brazed together with the anode 206 to form a continuous structure, which removes the possibility of air gaps. In addition, doing so allows for the selection of the heat slug 240 material, being optimal for heat transfer. For example, in one variation, the heat slug 240 comprises copper, while the anode comprises a tungsten-copper material. In addition, the configuration shown in 11B allows the heat slug 240 to move closer to the anode 206.

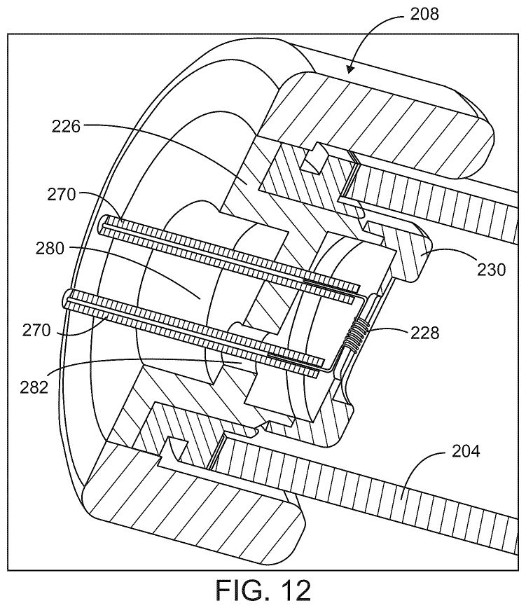

FIG. 12 shows a partial cross-sectional view of an improved cathode construction. The figure shows the ceramic tube 204, cathode 208, shaping cup 230, and filament body 226. In this variation, the filament body 226 includes a cavity 280 adjacent to where tubes 270 extend through the filament body 226 for housing the filament 228. The filament body 226 includes an increased gap 282 to accommodate one of the tubes 270. The cavity 280 and gap 282 are filled with glass to assist in vacuum sealing and electrically isolating the tube 270.

The X-ray tube 202 discussed above is intended as one variation of improved X-ray tubes under this disclosure. The following figures illustrate additional variations of alternative features for the anode body, cathode body, rod insert, conducting member, or any other component of the X-ray tube assemblies disclosed herein. It is also contemplated that the alternative features and designs shown herein can be combined with any other feature or design.

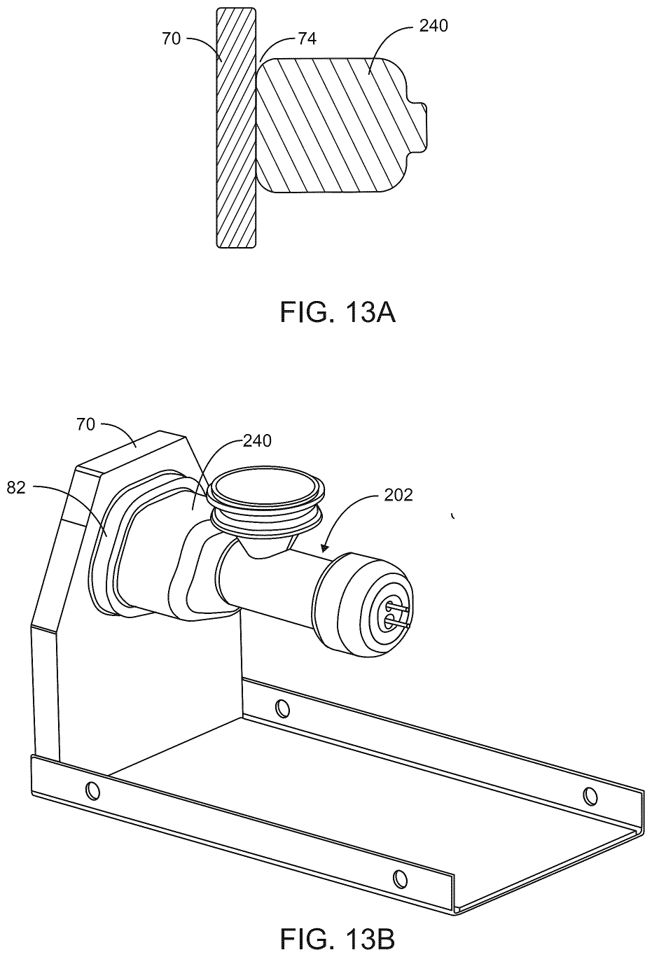

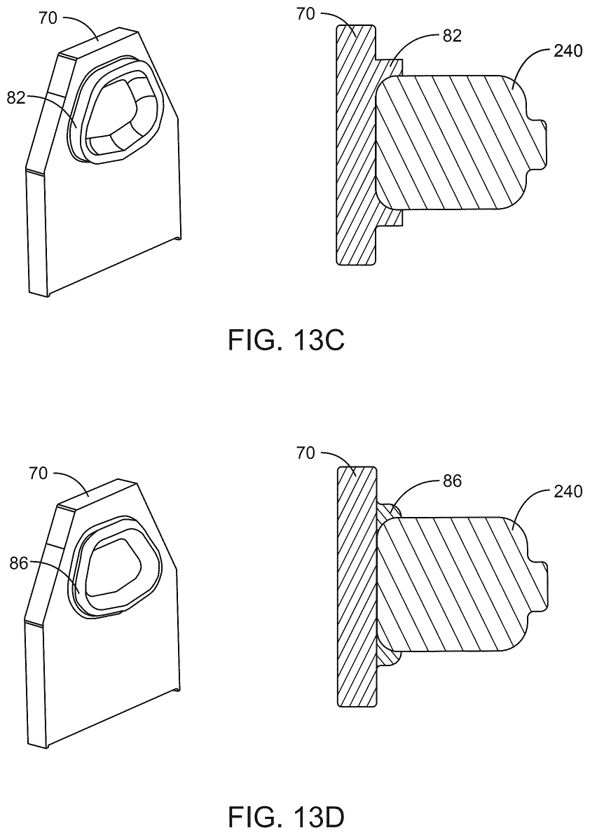

FIG. 13A shows a partial cross-section of a heat slug 240 that joins to a rear wall 70 in a monoblock assembly (e.g., see FIGS. 1B, 1C, and 13B). In a constructed monoblock, silicone potting fills the region outside of the heat slug 240 and interior to the wall 70. This region 74 brings together three materials, the heat slug (copper), the wall (beryllia), and the silicone potting, resulting in high field stress that can cause a breakdown of the monoblock in this region 74. FIG. 13B shows one example of an improved monoblock construction to prevent such breakdowns. As shown, the wall 70 can include a mated interface 82 to receive the heat slug 240, where the heat slug 240 and mated interface 82 are brazed together to reduce an electric field at the interface.

FIG. 13C illustrates a wall 70 with the mated interface 82 and a partial cross-sectional view of the slug 240 received within the mated interface 82 in the wall. FIG. 13D illustrates another variation where a dielectric filler 86 is positioned at the corner of the heat slug 240 and wall 70 interface. In one variation, the dielectric filler is selected to have a high dielectric constant to match the wall 70.

As for other details of the present invention, materials and manufacturing techniques may be employed within the level of those with skill in the relevant art. The same may hold true with respect to method-based aspects of the invention in terms of additional acts that are commonly or logically employed. In addition, though the invention has been described in reference to several examples, optionally incorporating various features, the invention is not to be limited to that which is described or indicated as contemplated with respect to each variation of the invention.

Various changes may be made to the invention described, and equivalents (whether recited herein or not included for the sake of some brevity) may be substituted without departing from the true spirit and scope of the invention. Also, any optional feature of the inventive variations may be set forth and claimed independently or in combination with any one or more of the features described herein. Accordingly, the invention contemplates combinations of various aspects of the embodiments or combinations of the embodiments themselves, where possible. Reference to a singular item, includes the possibility that there are plural of the same items present. More specifically, as used herein and in the appended claims, the singular forms “a,” “and,” “said,” and “the” include plural references unless the context clearly dictates otherwise.

It is important to note that where possible, aspects of the various described embodiments, or the embodiments themselves can be combined. Where such combinations are intended to be within the scope of this disclosure.

1. An X-ray tube comprising:
a ceramic structure;
a cathode body hermetically sealed to a first end of the ceramic structure;
an anode body hermetically sealed to a second end of the ceramic structure;
the anode body having a borehole intersecting with a conical X-ray window extending radially from the borehole, a target surface located within the borehole and adjacent to the conical X-ray window, the target surface formed to have an angle relative to an axis of the borehole that directs X-ray emission towards the conical X-ray window, where a portion of borehole adjacent to the target surface extends through the anode body to form a tunnel such that the target surface is recessed within the tunnel;
wherein an outer surface of the anode body comprises a first portion for coupling to an interior of the ceramic structure and a second portion that is radially offset from the interior of the ceramic structure; and
the cathode body having a filament coupled within a central cup portion and configured to emit electrons in an electron beam towards the anode upon the application of a current to the filament.

2. The X-ray tube of claim 1, wherein the target surface is located at an end of a rod, where the rod is inserted within the borehole opposite to the tunnel such that the target surface faces the cathode body.

3. The X-ray tube of claim 1, wherein the target surface comprises a flat surface.

4. The X-ray tube of claim 1, wherein the cathode body comprises a recess adjacent to the cup portion and having a stepped surface such that a first portion of the stepped surface is coupled to the interior of the ceramic structure and a second portion of the stepped surface is spaced from the interior of the ceramic structure.

5. The X-ray tube of claim 1, wherein the filament is located adjacent to a filament window within the cup structure and where a surface of the filament window is configured shape a path of electrons in the electron beam.

6. The X-ray tube of claim 1, further comprising a conducting member located adjacent to the conical X-ray window.

7. The X-ray tube of claim 6, wherein the conducting member comprises a thin foil material that covers an exterior opening of the conical X-ray window.

8. The X-ray tube of claim 6, wherein the conducting member is located within the conical X-ray window.

9. The X-ray tube of claim 6, wherein the conducting member extends partially or fully around a circumference of the anode body.

10. The X-ray tube of claim 6, wherein the conducting member is radially spaced from the interior of the ceramic structure.

11. The X-ray tube of claim 6, where the conducting member comprises a thin foil material that is configured to function as a getter to adsorb gas molecules inside the X-ray tube.

12. The X-ray tube of claim 1, wherein the borehole extends through the anode body.

13. The X-ray tube of claim 1, further comprising a heat slug affixed to the anode body.

14. The X-ray tube of claim 13, where anode body comprises a first material and the heat slug comprises a second material, where a thermal conductivity of the first material is different than a thermal conductivity of the second material.

15. The X-ray tube of claim 13, wherein the heat slug comprises a protrusion that extends partially within the anode body.

16.-19. (canceled)
